(19) United States
(12) Patent Application Publication
(10) Pub. No.: US 2005/0016677 A1
(43) Pub. Date: Jan. 27, 2005

(54) Two-component adhesive material and method of use therefor

(75) Inventors: David Carlson, Rochester Hills, MI (US); Michael J. Czaplicki, Rochester, MI (US); Brandon Madaus, Shelby Township, MI (US); Sandra Revoldt, Almont, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 10/847,016

(22) Filed: May 17, 2004

Related U.S. Application Data
(60) Provisional application No. 60/489,200, filed on Jul. 22, 2003.

(51) Int. Cl. C09J 5/00

(52) U.S. Cl. 156/330; 156/331.1

(57) ABSTRACT

There is disclosed a two-component adhesive material and method of use therefore. The two-component adhesive material is typically a cure-in-place adhesive that includes an amine component, an acid component, an epoxy component or a combination thereof.

### CLAIM OF BENEFIT OF FILING DATE

The present application claims the benefit of the filing date of U.S. Provisional Application Ser. No. 60/489,200, filed Jul. 22, 2003, hereby incorporated by reference.

### FIELD OF THE INVENTION

The present invention relates to a two-component material and its use in adhering members together for an article of manufacture such as an automotive vehicle.

### BACKGROUND OF THE INVENTION

Industry has developed numerous adhesive materials over the last fifty years. Depending upon the intended application of the adhesive material, it is typically desirable for the adhesive material to exhibit one or more characteristics that make it particularly desirable for its particular intended use. As an example, it may be desirable for an adhesive material to exhibit relatively long or relatively short cure times. As such, the present invention provides an adhesive material that exhibits one or more desirable properties, and an application for the adhesive material that takes advantage of the one or more desirable properties.

### SUMMARY OF THE INVENTION

A method of securing a member in an article of manufacture such as an automotive vehicle is disclosed. According to the method a member is provides, the member having a surface. A structure of the article of manufacture is also provided, the structure also having a surface Both the surface of the member and the surface of the structure are contacted with an adhesive material, which includes a resin component and a reactive component. Typically, the reactive component can activate or cure the resin component to assist in securing the member to the structure.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an automotive vehicle with a portion of a roof of the automotive vehicle being cut away.

FIG. 2 is a perspective view of an interior portion of the automotive vehicle of FIG. 1.

FIG. 3 is a perspective view of an applicator, which may be employed for applying an adhesive material of the present invention.

### DETAILED DESCRIPTION OF THE PREFERRED EMBODIMENT

The present invention is predicated upon the provision of an adhesive material and a method of using the material. The adhesive is preferably a two component adhesive material that is expandable, curable or both upon mixing a first component of the material with a second component. It is also preferable that the adhesive material can be formulated to have longer or shorter gel times, cure times or both depending upon the application for the adhesive material.

Generally, it is contemplated that the adhesive material may be employed for adhering nearly any members, components or portions together. According to one preferred embodiment, the adhesive material is employed to attach a first member of an automotive vehicle to a second member. Preferably, the first member is a part or portion of the body or frame of the vehicle and the second member is a reinforcement for the vehicle. As an example, the second member may be a shield (e.g., a bullet resistant steel plate) that is attached to a body member, a frame member or both of an automotive vehicle. Alternatively, the adhesive material may be employed to coat or cover a welded joint formed between members.

Advantageously, the longer cure times can allow for repositioning of a member after adhesively securing the member to a second member. Also advantageous, the shorter cure times can allow for faster assembly.

Generally, the adhesive material of the present invention will be formed from a first component, which is referred to as the resin component and a second component, which is referred to as the reactive component. As used herein the resin component is an admixture of ingredients and the reactive component is any ingredient or admixture of ingredients, which can cause the resin component to activate by expanding, curing or both.

Resin Component

The resin component is typically composed of an admixture of two or more of the following ingredients: polymer resins, blowing agents, fillers or the like. Preferably, although not required, the ingredients of the resin component are substantially non-reactive with each other at room temperature in the absence of any additional chemicals or conditions.

A wide variety of polymer resins may be suitable for the resin component of the present invention, however epoxy resins are preferable. Epoxy resin is used herein to mean any of the conventional dimeric, oligomeric or polymeric epoxy materials containing at least one epoxy functional group. The polymer-based materials may be epoxy containing materials having one or more oxirane rings polymerizable by a ring opening reaction. In preferred embodiments, the adhesive material includes up to about 99% epoxy resin. More preferably, the adhesive material includes between about 50% and 95% by weight epoxy resin and still more preferably between about 80% and 90% by weight epoxy resin.

The epoxy may be aliphatic, cycloaliphatic, aromatic or the like. The epoxy may be supplied as a solid (e.g., as pellets, chunks, pieces or the like) or a liquid (e.g., an epoxy resin). The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Preferably, an epoxy resin is added to the expandable material to increase the flow properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin, which may be modified with butadiene or another polymeric additive.

When used, various blowing agents may be employed with the present invention and the choice of blowing agents can depend upon the suitability of the blowing agent for use with one or both of the resin component and the reactive component. Examples of blowing agents include chemicals with one or more nitrogen containing groups such as amides, amines and the like. According to one preferred embodiment, it is contemplated that the resin component of the present invention is formulated with a physical blowing agent and, more particularly, a blowing agent having a thermoplastic shell with a solvent core. An example of a preferred blowing agent, which according to the present invention is formulated with the resin component, is sold under the trade name EXPANCEL 820-DU and is commercially available from Expancel Inc., 2240 Northmont Parkway, Duluth, Ga., 30096 or Expancel, Box 13000, S-850 13 Sundsvall, Sweden. Preferably, the solvent core of the blowing agent of the present invention is a liquid, but such is not required.

When used, blowing agents can comprise up to about 20% by weight of the resin component. Preferably, however, the resin component includes between about 0.5% and about 12% by weight blowing agent and more preferably between about 2% and about 5% by weight blowing agent.

The resin component typically includes one or more fillers, including but not limited to particulated materials (e.g., powder), fibrous materials, beads, microspheres, or the like. Preferably the filler includes a relatively low-density material that is generally non-reactive with the other components present in the expandable material.

Examples of fillers include silica, diatomaceous earth, glass, clay, talc, pigments, colorants, glass beads or bubbles, glass, carbon ceramic fibers, antioxidants, and the like. Such fillers, particularly clays, can assist the expandable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride.

Other fillers include mineral or stone type fillers such as calcium carbonate, sodium carbonate or the like. It is also contemplated that silicate minerals such as mica may be used as fillers. Further, metal-containing materials such as titanium dioxide, aluminum materials (e.g., alumina trihydrate) might also be employed.

When employed, the fillers in the resin component can range from 3% to 90% by weight of the resin component. Preferably, the resin component includes between about 4% and about 35% by weight filler and more preferably between about 10% and about 20% by weight filler.

Reactive Component

The reactive component is typically composed of a curing agent and preferably also includes one or more fillers or additives. Preferably, although not required, the ingredients of the reactive component are substantially non-reactive with each other at room temperature in the absence of any additional chemicals or conditions. Generally speaking, the fillers or additives discussed with regard to the resin component can also be employed in the reactive component.

The curing agent of the reactive component can depend upon the ingredients of the resin component and the desired interactions between the reactive component and the resin component. Of particular concern for the present invention are the gel or cure times of the adhesive material formed by combining the resin component and the reactive component.

For lengthier gel or cure times, amines are preferably employed as the activating agent, curing agent or hardener in the reactive component. The amines may be cyclic, non-cyclic, aromatic, non-aromatic, aliphatic, non-aliphatic, modified or unmodified cyclo-aliphatic, combinations thereof or the like. Exemplary amines include, without limitation, polyamines, polyamides, polyamidos, piperazines, imidazoles, combinations thereof or the like, which may be modified or non-modified.

For shorter gel or curing time, acids are preferably employed as the activating agent, curing agent or hardener in the reactive component and the acids preferably have a pH less than about 5 (e.g., around 2 to 3). The acids may be organic acids, inorganic acids, combinations thereof or the like. Exemplary acids include, without limitation, citric acid, hydrochloric acid, phosphoric acid, sulfuric acids, combinations thereof or the like.

While it is contemplated that acids alone or amines alone may be employed as the sole activating agent, curing agent or hardener, it is also contemplated that the acids or amines may be combined as the activating agent, curing agent or hardener. Moreover, it is contemplated that additional activating agents, curing agents or hardeners may be employed in combination with the amines, the acids or a combination thereof.

Shorter gel or cure times are preferably less than 15 minutes, more preferably less than 10 minutes and even more preferably less than 5 minutes. Longer gel or cure times are preferably greater than 15 minutes, more preferably greater than 25 minutes and even more preferably greater than 30 minutes.

The ratio of resin component to reactive component is typically in a range of about 10:1 to about 1:10 and more preferably within a range of about 6:1 to about 1:6. When an acid is employed as a primary activating agent (e.g., at least about 60% by weight of any activating agents in the reactive component) in the reactive component, the ratio of resin component to reactive component is typically in the range of about 10:1 to about 1:2, more preferably in the range of about 8:1 to about 1:1 and even more preferably in the range of about 6:1 to about 2:1 (e.g., about 4:1). When an amine is employed as a primary activating agent (e.g., at least about 60% by weight of any activating agents in the reactive component) in the reactive component, ration of the resin component to the reactive component is typically in the range of about 6:1 to about 1:6, more preferably about 4:1 to about 1:4 and even more preferably about 2:1 to about 1:2 (e.g., about 1:1).

Other Additives

Other additives, agents or performance modifiers may also be included in the components of the adhesive material as desired, including but not limited to a UV resistant agent, a flame retardant, a Theological modifier, an impact modifier, a heat stabilizer, a colorant, a pigment, a processing aid, a lubricant, a reinforcement (e.g., chopped or continuous glass, ceramic, aramid, or carbon fiber or the like).

Particularly preferred additives can assist in providing shear-thinning properties (i.e., an increased viscosity at a zero shear rate and a decreased viscosity at a higher shear rate) to the adhesive material. One exemplary preferred additive of the present invention is a thixotropic additive. An example of such a thixotropic additive is an aramid pulp and is sold under the trade name KEVLAR 1F543. In a particularly preferred embodiment, the thixoptropic additive is added to both the resin component and the reactive component prior to combining the resin component with the reactive component. Advantageously, the thixotropic additive can effectuate shear thinning. When used, the thixotropic additive represents between about 0.1% and about 10%, more preferably between about 0.7% and about 5% and even more preferably between about 1% and about 3% of resin component, the reactive component or both.

One preferred exemplary formulation of a two-part adhesive material having a relatively short gel or cure time is shown in Table A below:

TABLE A

| Chemical Name | Weight % |
|---|---|
| Resin Component | |
| Polymer of Epichlorohydrin-Polyglycol | 38.36 |
| Reaction product of epichlorohydrin | 38.36 |
| and bisphenol A | |
| P-Aramid Pulp (Opened) | 1.28 |
| Copolymer (>80%), Blowing Agent | 3.84 |
| (isobutane) (10-15%), & Residual | |
| Monomer-Acrylonitrile (<0.01%) | |
| Alkyl Quaternary Ammonium Clay | 10.23 |
| (Smectite group mineral, Sepiolite, | |
| Dimethyl ammonium chloride, | |
| Eimethyl benzyl ammonium chloride) | |
| Alumina Trihydrate (non-fibrous) | 7.67 |
| Phthalocyanine, Pigment Blue 15 | 0.26 |
| Total, Resin Component | 100.00 |
| Part B | |
| Phosphoric Acid (70%) & Water | 67.00 |
| (30%) | |
| Rheological Additive - Castor Wax | 33.00 |
| Total, Reactive Component | 100.00 |

One preferred exemplary formulation of a two-part adhesive material having a relatively long gel or cure time is shown in Table B below:

TABLE B

| Chemical Name | Weight % |
|---|---|
| Resin Component | |
| Polymer of Epichlorohydrin-Polyglycol | 42.73 |
| Reaction product of epichlorohydrin | 42.73 |
| and bisphenol A | |
| P-Aramid Pulp (Opened) | 1.40 |
| Alkyl Quaternary Ammonium Clay | 4.30 |
| (Smectite group mineral, Sepiolite, | |
| Dimethyl ammonium chloride, | |
| Eimethyl benzyl ammonium chloride) | |
| Alumina Trihydrate (non-fibrous) | 8.54 |
| Organic Pigment, Pigment Orange 16 | 0.30 |
| Total, Resin Component | 100.00 |
| Reactive Component | |
| Aminoethyl) Piperazine 1-(2, (AEP)) | 64.03 |
| (50%)& Nonylphenol (50%) | |
| Calcined Kaolin (99%) & Titanium | 25.40 |
| Dioxide (1%) | |
| Modified Imidazoles, Imidazole, | 9.87 |
| Acrylate | |
| P-Aramid Pulp (Opened) | 0.70 |
| Total, Reactive Component | 100.00 |

Applications

Generally, the adhesive material may be employed to attach (e.g., adhesively secure) any first member or portion of an article of manufacture to any second member or portion of the automotive. It has been found, however, that the adhesive material has been particularly useful for attaching reinforcement members to various members of an automotive vehicle. It has also been found that the adhesive material is useful as a protective coating for certain portion of an automotive vehicle and/or as a seal for various cavities of an automotive vehicle.

In one particular embodiment, the adhesive material is used to adhesively secure a reinforcement panel into an opposing and generally coextensive relation with a panel (e.g., a body panel) of an automotive vehicle. In the embodiment, the adhesive material is typically applied to a surface of the reinforcement panel, a surface of the vehicle panel or both. Also, the reinforcement panel is placed in opposing relation to the vehicle panel such that the adhesive material contacts both the surface of the vehicle panel and the surface of the reinforcement panel. Then, the reinforcement panel and the vehicle panel are held substantially stationary relative to each other to allow the adhesive material to cure for a predetermined amount of time, which will typically depend upon the formulation of the adhesive material.

Upon curing, the adhesive material will typically at least assist in securing the reinforcement panel to the vehicle panel. In addition to the adhesive material, however it is contemplated that additional fasteners such as welds, mechanical fasteners or the like may be employed for assisting in securing the reinforcement panel to the vehicle panel. Advantageously, the adhesive material will also typically assist in eliminating noise or vibration within the vehicle.

The reinforcement panels may be formed of a variety of materials including polymeric materials (e.g., nylon), metal materials, other materials or combinations thereof. In preferred embodiments, the reinforcement panels are formed of a material that is impenetrable by high speed projectiles such as bullets or fragments resulting from explosions although not required. Exemplary materials typically include one or metals such as aluminum, steel, magnesium, iron, titanium, combinations thereof or the like. Other exemplary materials include aramids, ceramics, combinations thereof or the like.

### EXAMPLES

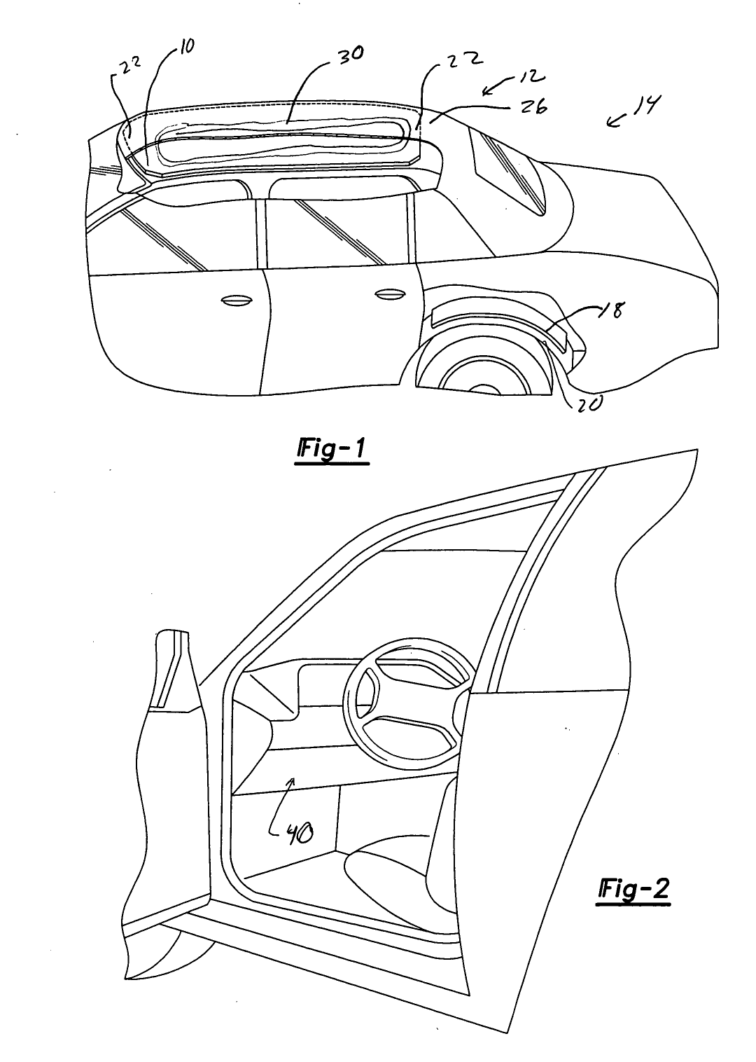

Referring to FIG. 1, there is illustrated a steel reinforcement panel 10 for reinforcing a roof 12 of an automotive vehicle 14 and a steel reinforcement panel 18 for reinforcing a wheel well panel 20 of the automotive vehicle 14. The reinforcement panel 10 for the roof 12 is substantially planar and is tapered at opposite ends 22 of the panel 10 for corresponding to the general shape of an outer roof panel 26 of the roof 12. The reinforcement panel 18 for the wheel well panel 20 is contoured to correspond to the contoured shape of the wheel well panel 20. Of course, it is contemplated that the reinforcement of the present invention may be shaped as needed or desired and may or may not correspond to the member being reinforced. Moreover, it is contemplated that various reinforcements may be designed within the scope of the present invention for reinforcing various panels or other structure of the automotive vehicle.

In the exemplary embodiment, an amount of adhesive material 30 in accordance with the present invention is applied to a surface of the reinforcement panel 18. Although the adhesive may be applied using a variety of techniques, one preferred technique includes applying the material with a metering gun 34 such as that shown in FIG. 3. Advantageously, such a gun can maintain the resin component of the adhesive material separate from the reactive component until application, upon which the gun provides and mixes the components during dispensing to form the adhesive material.

After application of the adhesive material, the reinforcement panel 10 is placed in opposing relation to the roof panel 26 of the roof 12 such that the adhesive contacts a surface of the roof panel 26 and the surface of the reinforcement panel 10. Such placement may include the use of mechanical devices such as jacks or other devices to assist in moving the reinforcement panel 10. Preferably, although not required, roof bows of the automotive vehicle are removed to allow greater access to the roof panel 26. The reinforcement panel 10 is then held in place as the adhesive material cures to assist in securing to the reinforcement panel 10 to the roof panel 26.

In addition to the adhesive material, one or more welds (e.g., spot welds) are formed between the roof panel 26 and the reinforcement panel 10 for additionally securing the reinforcement panel 10 to the roof panel 26. In situations where welding is performed near the adhesive material, it is preferable for the adhesive material to be flame resistant, heat resistant or both.

The reinforcement panel 18 for the wheel well panel 20 is assembled to the vehicle in a manner substantially identical to that described for assembly of the reinforcement panel 18 to the roof panel. Moreover, it is contemplated that a reinforcement panel may be configured to oppose nearly any panel of the automotive vehicle.

Advantageously, the adhesive material of the present invention can be formulated to have relatively long gel times as previously described. Such extended gel times allow for enough time for the reinforcement to be properly placed prior to curing of the adhesive material. Thus, the reinforcement may be moved and adjusted for getting a more desirable positioning of the reinforcement relative to other components of an article of manufacture. As an additional advantage, the adhesive material, once cured, provides vibration damping between the reinforcement and a component (e.g., a panel) to which the reinforcement is applied. Thus, the adhesive material can reduce noise and other undesirable traits, which may be exhibited by an article of manufacture (e.g., an automotive vehicle).

In another embodiment, the adhesive material of the present invention may be employed for protecting portions of an article of manufacture. For example, the adhesive material may be applied to protect portions of an article of manufacture (e.g., an automotive vehicle) that have been charred or deformed by welding or other operation since such portions can be particularly susceptible to corrosion.

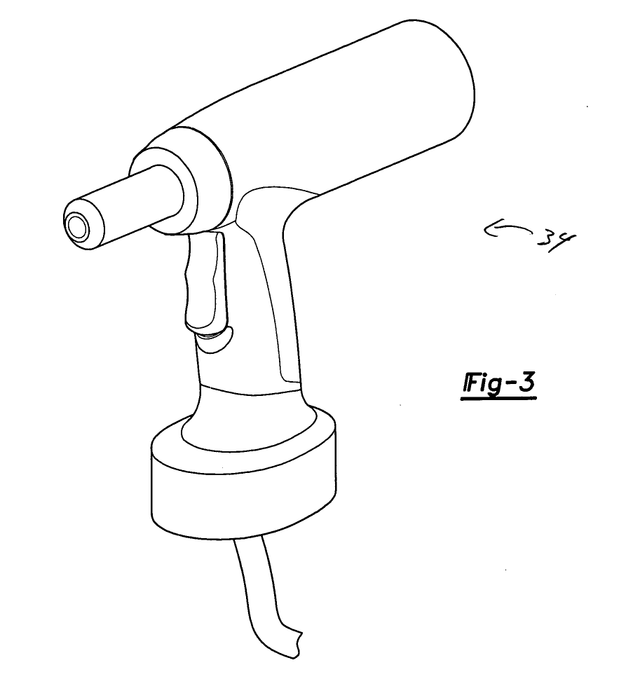

Referring to FIG. 2, it is contemplated the adhesive material of the present invention may be employed for assisting in securing a reinforcement (e.g., a panel as disclosed herein) within the cowl or dashboard area 40 of the vehicle. Moreover, the adhesive material may assist in securing a reinforcement within a pillar (e.g., an A, B or C-pillar) of the vehicle or may be applied in such a pillar by itself for reinforcement, corrosion resistance, sealing, baffling, a combination thereof or the like.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method of securing a member in an article of manufacture, comprising:
providing the member, the member having a surface;
providing a structure of the article of manufacture, the structure also having a surface;
contacting the surface of the member and the surface of the structure with an adhesive material, the adhesive material including:
i) a resin component; and
ii) a reactive component wherein the reactive component can activate or cure the resin component; and
curing the adhesive material to assisting in securing the member to the structure.

2. A method as in claim 1 wherein the resin component includes a blowing agent.

3. A method as in claim 1 wherein the curing time for the adhesive material is less than 10 minutes

4. A method as in claim 1 wherein the curing time for the adhesive material is greater than 25 minutes.

5. A method as in claim 1 wherein the reactive component is an acid and a ratio of the resin component to the reactive component is in the range of about 6:1 to about 2:1.

6. A method as in claim 1 wherein the reactive component is an amine and a ratio of the resin component to the reactive component is in the range of about 2:1 to about 1:2.

7. A method as in claim 1 wherein at least one of the resin component or the reactive component includes an aramid pulp.

8. A method as in claim 1 wherein the adhesive material includes a flame retardant.

9. A method of securing a member in an article of manufacture, comprising:
providing the member, the member having a surface;
providing a structure of the article of manufacture, the structure also having a surface;
contacting the surface of the member and the surface of the structure with an adhesive material, the adhesive material including:
i) a resin component, the resin component including an epoxy resin; and
ii) a reactive component that includes an amine or an acid wherein the reactive component can activate or cure the resin component; and
curing the adhesive material to assisting in securing the member to the structure.

10. A method as in claim 9 wherein the resin component includes a blowing agent.

11. A method as in claim 9 wherein the curing time for the adhesive material is less than 10 minutes

12. A method as in claim 9 wherein the curing time for the adhesive material is greater than 25 minutes.

13. A method as in claim 9 wherein the reactive component is an acid and a ratio of the resin component to the reactive component is in the range of about 6:1 to about 2:1.

14. A method as in claim 9 wherein the reactive component is an amine and a ratio of the resin component to the reactive component is in the range of about 2:1 to about 1:2.

15. A method as in claim 9 wherein at least one of the resin component or the reactive component includes an aramid pulp.

16. A method as in claim 9 wherein the adhesive material includes a flame retardant.

17. A method as in claim 9 wherein the amine is an imidazole and the acid is a phosphoric acid.

18. A method of securing a member in an article of manufacture, comprising:
providing the member, the member having a surface, the member being a bullet resistant steel plate;
providing a structure of the automotive vehicle, the structure also having a surface, the structure being a roof or a wheel well of the automotive vehicle;
contacting the surface of the member and the surface of the structure with an adhesive material, the adhesive material including:
i) a resin component that includes between about 50% and 95% by weight epoxy resin, 3% to 90% by weight one or more fillers; and
ii) a reactive component that includes an imidazole or a phosphoric acid wherein the reactive component can activate or cure the resin component;
positioning the member after the contacting step; and
curing the adhesive material to assisting in securing the member to the structure.
